(19) United States
(12) Patent Application Publication
(10) Pub. No.: US 2026/0227986 A1
(43) Pub. Date: Aug. 6, 2026

(54) SYSTEMS, METHODS AND COMPUTING APPARATUSES FOR UPDATING VEHICLE SYSTEMS

(71) Applicant: Toyota Jidosha Kabushiki Kaisha, Toyota-shi (JP)

(72) Inventors: Ana Sofia Rufino Ferreira, Palo Alto, CA (US); Moritz Niendorf, Palo Alto, CA (US); Peyman Yadmellat, Palo Alto, CA (US)

(73) Assignee: Toyota Jidosha Kabushiki Kaisha, Toyota-shi (JP)

(21) Appl. No.: 19/042,587

(22) Filed: Jan. 31, 2025

(51) Int. Cl. G06F 8/65; G06F 8/10

(52) U.S. Cl. CPC G06F 8/65; G06F 8/10

(57) ABSTRACT

In one embodiment, a method of providing an update to a vehicle includes receiving a first set of vehicle system requirements for a first vehicle system and a second set of vehicle system requirements for a second vehicle system, inputting the first set of vehicle system requirements and the second set of vehicle system requirements into a model trained to identify conflicts between rules of different vehicle system requirements, receiving a report from the model identifying one or more conflicts between the first set of vehicle system requirements and the second set of vehicle system requirements, receiving an updated first set of vehicle system requirements and/or an updated second set of vehicle system requirements, and wirelessly transmitting, to the vehicle, the update such that the vehicle operates according to the update.

### BACKGROUND

Today's vehicles have many complex systems that work together to successfully propel the vehicle through the environment. Assistive driving systems, such as lane keep assist systems, lane departure warning systems, and adaptive crews control systems, function to make driving a less taxing experience for the driver. Each of the vehicle systems have their own unique requirements. However, the requirements of each vehicle system must operate in concert with one another. Thus, there should not be conflicts between the requirements of different vehicle systems. For example, the requirements of a lane departure warning system must not conflict with requirements of a lane keep assist system.

As vehicle systems become more and more advanced, it is difficult to identify conflicting requirements between various vehicle systems. There may be conflicts that are undetectable. These conflicts may cause undesirable vehicle operation.

Accordingly, alternative ways to detect conflicts between vehicle system requirements may be desired.

### SUMMARY

In one embodiment, a method of providing an update to a vehicle includes receiving a first set of vehicle system requirements for a first vehicle system and a second set of vehicle system requirements for a second vehicle system, inputting the first set of vehicle system requirements and the second set of vehicle system requirements into a model trained to identify conflicts between rules of different vehicle system requirements, receiving a report from the model identifying one or more conflicts between the first set of vehicle system requirements and the second set of vehicle system requirements, receiving an updated first set of vehicle system requirements and/or an updated second set of vehicle system requirements, and wirelessly transmitting, to the vehicle, the update in the form of at least one of the first set of vehicle system requirements, the second set of vehicle system requirements, the updated first set of vehicle system requirements, and the updated second set of vehicle system requirements such that the vehicle operates according to the update.

In one embodiment, a computing apparatus includes one or more processors and a non-transitory memory storing instructions that, when executed by the one or more processors, configure the computing apparatus to receive a first set of vehicle system requirements for a first vehicle system and a second set of vehicle system requirements for a second vehicle system, input the first set of vehicle system requirements and the second set of vehicle system requirements into a model trained to identify conflicts between rules of different vehicle system requirements, receive a report from the model identifying one or more conflicts between the first set of vehicle system requirements and the second set of vehicle system requirements, receive an updated first set of vehicle system requirements and/or an updated second set of vehicle system requirements, and wirelessly transmit, to the vehicle, the update in the form of at least one of the first set of vehicle system requirements, the second set of vehicle system requirements, the updated first set of vehicle system requirements, and the updated second set of vehicle system requirements such that the vehicle operates according to the update.

In another embodiment, a system includes a vehicle and a computing apparatus. The computing apparatus includes one or more processors and a non-transitory memory storing instructions that, when executed by the one or more processors, configure the computing apparatus to receive a first set of vehicle system requirements for a first vehicle system and a second set of vehicle system requirements for a second vehicle system, input the first set of vehicle system requirements and the second set of vehicle system requirements into a model trained to identify conflicts between rules of different vehicle system requirements, receive a report from the model identifying one or more conflicts between the first set of vehicle system requirements and the second set of vehicle system requirements, receive an updated first set of vehicle system requirements and/or an updated second set of vehicle system requirements, and wirelessly transmit, to the vehicle, the update in the form of at least one of the first set of vehicle system requirements, the second set of vehicle system requirements, the updated first set of vehicle system requirements, and the updated second set of vehicle system requirements such that the vehicle operates according to the update.

### BRIEF DESCRIPTION OF THE SEVERAL VIEWS OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 illustrates an example vehicle according to one or more embodiments described and illustrated herein.

FIG. 2 illustrates a plurality of vehicle systems according to one or more embodiments described and illustrated herein.

FIG. 3 illustrates an example workflow of a method for identifying vehicle system requirement conflicts according to one or more embodiments described and illustrated herein.

FIG. 4 illustrates an example system for updating a vehicle with updated vehicle system requirements according to one or more embodiments described and illustrated herein.

FIG. 5 illustrates example internal components of a computing apparatus for identifying vehicle system requirement conflicts according to one or more embodiments described and illustrated herein.

FIG. 6 illustrates an example method for updating vehicle system requirements of a vehicle according to one or more embodiments described and illustrated herein.

### DETAILED DESCRIPTION

Embodiments of the present disclosure are directed to systems, methods and computing apparatuses operable to quickly and efficiently identify conflicting requirements between different vehicle systems. More specifically, embodiments of the present disclosure utilize a trained model that receives sets of vehicle system requirements for different vehicle systems as an input, and then generates an output that includes information regarding any conflicts between requirements that are found. This conflict information may then be used by vehicle designers or other personnel to update certain requirements as needed to resolve the identified conflicts. The updated requirements may then be provided to one or more vehicles by an update process such that the one or more vehicles operate using the updated requirements.

Various systems, methods and computing devices for identifying conflicting vehicle system requirements are described in detail below.

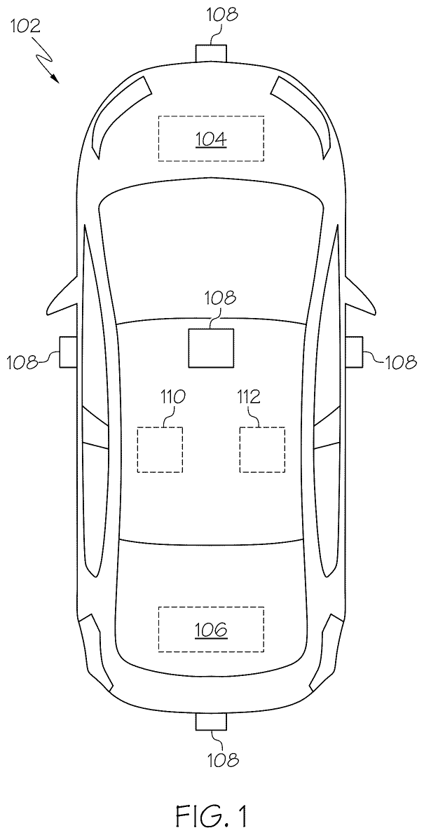

Referring now to FIG. 1, an example vehicle 102 is illustrated. The vehicle 102 may be any type of vehicle, such as an automobile, a truck, a van, a motor boat, a motorcycle, and any other vehicle that is operable to move people or goods. The vehicle 102 may be an electric vehicle having batteries and an electric motor, an internal combustion vehicle having an engine, a fuel-cell vehicle, or a hybrid vehicle having both an electric motor and an engine. The vehicle 102 further includes a fuel or battery system 106 operable to provide fuel (e.g., gasoline or diesel) and/or electrical charge to the engine and/or motor of the powertrain 104.

The powertrain 104 may include one or more of an electric motor and an internal combustion engine. The powertrain 104 is operable to longitudinally propel the vehicle 102 forward and backward. The vehicle 102 further includes a plurality of sensors 108 operable to generate data regarding the operation of the vehicle 102 and the environment in which the vehicle 102 is traveling. The plurality of sensors 108 may include any type of sensor, such as a camera, a lidar sensor, a proximity sensor, a speedometer, an inertia measurement unit (e.g., an accelerometer or a gyroscope), a thermometer, and any other sensor capable of generating relevant data.

The vehicle 102 further includes a global positioning (GPS) device 112 that is operable to receive signals from satellites orbiting the Earth to establish a position on the Earth. The GPS device 112 may be used by navigational and/or autonomous driving systems of the vehicle 102, for example.

The vehicle 102 also includes a plurality of vehicle systems 110, with each vehicle systems 110 performing a separate vehicle function. Any number of vehicle systems 110 for any number of functions may be provided. For example, the plurality of vehicle systems 110 may include an audio system, an autonomous driving system, a braking system, a lane keeping system, a climate system, and any other system capable of performing a vehicle function.

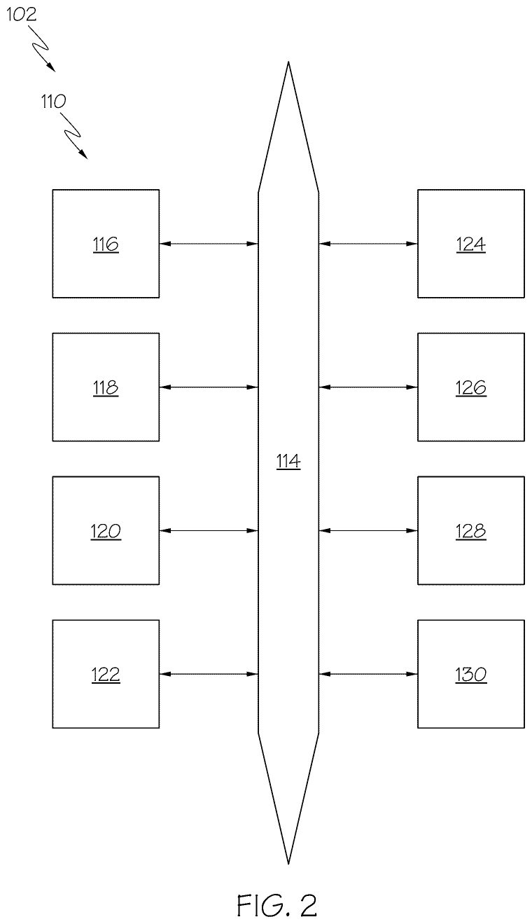

Referring now to FIG. 2, a plurality of vehicle systems 110 are illustrated as communicating over a communications bus 114. As stated above, any number of vehicle systems may be provided. Non-limiting examples include an autonomous driving system operable to autonomously control the vehicle 102, a lane keeping system 118 operable to keep the vehicle 102 within lane lines of a road, an adaptive cruise control system 120 is operable to maintain appropriate distance from a lead vehicle and to maintain set speeds, an infotainment system 120 includes audio and visual sub-systems, a braking system 122 (e.g., including anti-lock brake systems), a forward collision warning system 124, a lane departure system 126, a traffic signal recognition system 128, and a climate system 130.

Each one of these vehicle systems 110 includes a set of requirements, such as rules and operating parameters. As non-limiting examples, a lane keeping system 118 may have a requirement that the vehicle operate within certain distances from lane lines, an adaptive cruise control system 120 may have requirements on acceleration and deceleration, an autonomous driving system 116 may have requirements on camera sensors, such as viewing distance and resolution. These are only a few of the many thousands of requirements of the various vehicle systems 110. Some requirements may be minor, while others play a significant role in operation of the vehicle 102.

Governments may also put certain requirements on various vehicle functions, such as how an autonomous vehicle system operates, or how a forward collision warning system must operate and warn a driver.

Vehicle designers and engineers put significant effort into both developing the requirements of the various vehicle systems 110, as well as developing and integrating software and hardware components of the vehicle 102 that meet those requirements. However, a change to one vehicle system 110 may cause some unintended effect in another system. Some of these effects may be detrimental. Thus, there may be conflicts between requirements of two or more vehicle systems that should be resolved for proper operation of the vehicle. As a non-limiting example, a requirement of the lane keeping system 118 may be at odds with a requirement of the adaptive cruise control system 120. As another example, a lane keeping system 116 may have certain requirements regarding the capability of the sensors 108, such as cameras. It is common for vehicles to be sold at different trim levels, with higher, more expensive trim levels typically having more capable hardware, such as sensors 108, while lower, more inexpensive trim levels typically have less capable hardware. A sensor suite of a lower trim level may not meet the requirements of various vehicle systems, such as the lane keeping system 118.

Due to the thousands of requirements and significant details and information regarding the plurality of vehicle systems 110, it can be very difficult to find conflicts between the requirements of the plurality of vehicle systems 110. A minor change in one vehicle system can lead to significant detrimental and undesirable consequences in another, unrelated system.

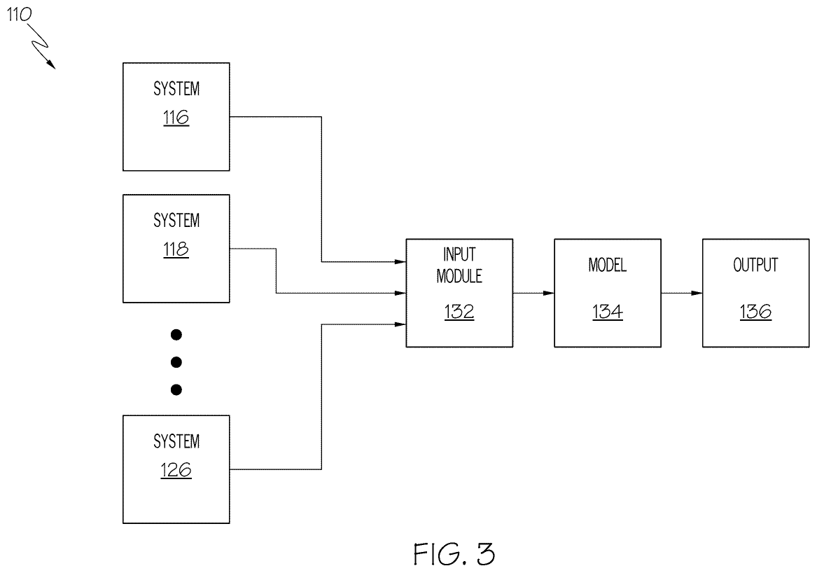

Embodiments of the present disclosure utilize a trained model to identify requirement conflicts between various vehicle systems 110 in a timely manner prior to the vehicle systems 110 being put into production or during a software update. Referring to FIG. 3, a trained model 134 receives the rules and requirements of a plurality of vehicle systems and identifies any conflicts in a report that is provided as an output 136. This report is then used by vehicle designers and engineers to produce updated requirements, software and/or hardware that are then evaluated again until the report of the model 134 indicates that there are no conflicts.

The trained model 134 may be any known or yet-to-be-developed large language model, as a non-limiting example. The trained model 134 is trained to recognize conflicts between the requirements of various vehicle systems 110. For example, training data for the model may include vehicle system requirements and simulated or real-world operational data of vehicles operating using the vehicle system requirements among other typical data used to train a large language model like web scrapes, scientific or non-scientific articles, technical manuals and documentations, books, online forums, and videos. Additionally, the trained model 134 can be trained using data from previously known conflicts, previous system failure on road observed in previous updates or similar vehicles/systems, disengagements, and collision reports. The model 134 is therefore trained to predict vehicle performance based on the configuration of the vehicle system(s). For example, the model 134 can predict how a vehicle will perform under a lane keeping system having certain requirements. During run time, the model 134 can compare the performance of the vehicle under various vehicle systems to the sets of requirements of the various vehicle systems. In this manner, the model 134 is operable to detect conflicts when certain requirements are not met.

As further examples, the trained model 134 can predict if certain requirements for comfort can impose undesirable risks. For example, one system limiting the maximum deceleration for comfort can conflict with requirements for a collision avoidance system. As another example, requirements for lane departure system may conflict with another system for variable lateral positioning to ensure certain distance with adjacent vehicles such as parked cars.

In some embodiments, the requirements of each vehicle system 110 being evaluated are formatted into a standard, normalized format that is then converted into a prompt by an input module 132 for the trained model 134. The input module 132 may receive the requirements and any other relevant data from the various systems, such as operational data in the form of sensors that generate data while the vehicle operates. As a non-limiting example, the input module 132 may use heuristics to generate a prompt from the requirements. As another non-limiting example, the input module 132 may be configured as a large language model that is operable to receive the requirements of the various systems and output a prompt that is then provided to the trained model 134. The output of the input module 132 may be in a JSON file, for example. In other embodiments, no input module 132 is provided, and the requirements of the various systems under evaluation are provided directly to the trained model 134.

The prompt that is provided to the trained model 134 requests that the model return any conflicts that are present within the requirements of the evaluated systems. For example, a first system may require that the vehicle perform a maneuver that would violate the requirements of a second system. As another example, the operating parameters of various hardware components of one or more systems may meet the requirements of a first system but fail to meet the requirements of a second system.

The output 136 includes all of the conflicts that are present between the evaluated systems. Embodiments are not limited by the format of the output 136, and generally it is in a format that is understood by design personnel so that they may update the designs of the systems that are in conflict. In this manner, embodiments of the present disclosure enable design personnel to quickly and efficiently identify system requirement conflicts so that they may be addressed in a timely manner. The conflicting vehicle system requirements may be updated to generated updated vehicle system requirements that may be further evaluated until there are no longer any conflicts. In some embodiments, the output 136 includes suggestions on different ways that

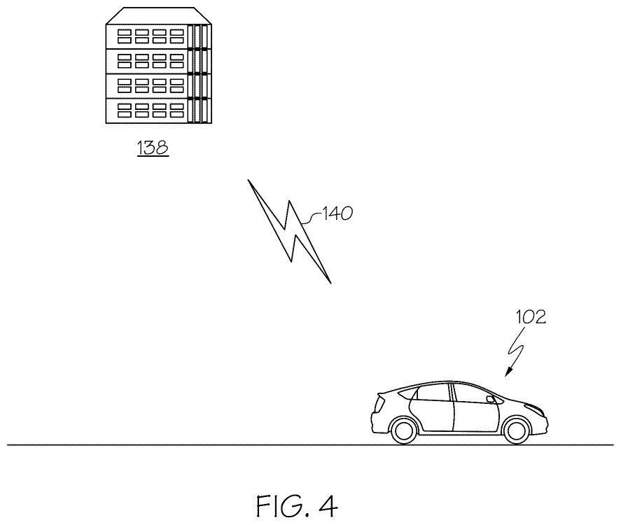

The updated sets of vehicle system requirements (as well as non-updated sets of vehicle system requirements) may be received by the system, and transmitted the one or more vehicles during an update process. Referring to FIG. 4, the requirements (i.e., updated and/or non-updated requirements) may be sent from a remote server 138 to vehicles 102 by a wireless signal 140 during an over-the-air update, for example. As another example, a vehicle manufacturer or dealership may perform a wired update whereby the requirements are uploaded to the vehicles 102 by a wired connection. The vehicles 102 then operate according to the updated and non-updated sets of vehicle system requirements. For example, an updated set of autonomous driving system requirements may cause a vehicle 102 to autonomous operate according to the updated driving system requirements (e.g., make turns differently, have a different acceleration profile, recognize objects differently).

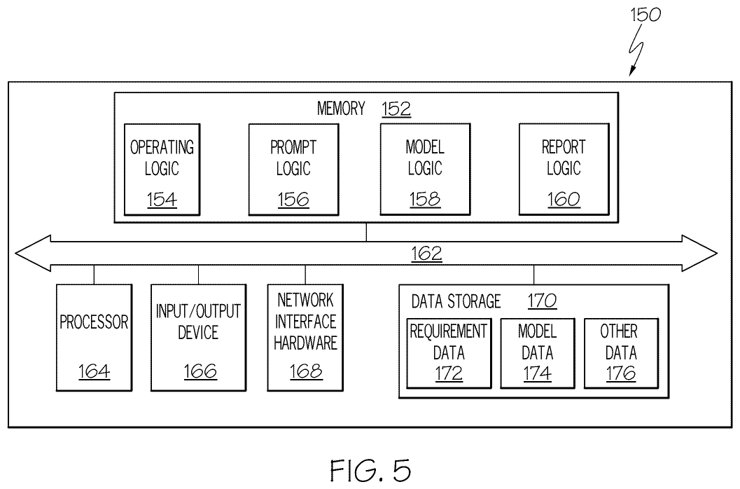

Referring now to FIG. 5, components of an example computing apparatus 150 are illustrated. The example computing apparatus 150 provides a system for identifying conflicts of different sets of vehicle system requirements, and/or a non-transitory computer usable medium having computer readable program code for identifying conflicts of different sets of vehicle system requirements embodied as hardware, software, and/or firmware, according to embodiments shown and described herein. It should be understood that the software, hardware, and/or firmware components depicted in FIG. 5 may also be provided in multiple computing apparatuses or devices external to computing apparatus 150 depicted in FIG. 5 (e.g., data storage devices, remote server computing devices, and the like).

As also illustrated in FIG. 5, the computing apparatus 150 may include a one or more processors 164, input/output devices 166, network interface hardware 168, and a data storage device (which may store requirement data 172, model data 174 and any other data 176 for performing the functionalities described herein), and a non-transitory memory component 152. The non-transitory memory component 152 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. In other embodiments, the non-transitory memory component 152 may be defined by transitory memory and/or signals.

The requirement data 172 may include data relating to the various vehicle system requirements. The model data 174 may include any data relating to the functionality and operation of the trained model 134. Other data 176 may include any other data for performing the functionalities described herein.

Additionally, the non-transitory memory component 152 may be configured to store operating logic 154 that provides a local operating system for the computing apparatus 150, prompt logic 156, model logic 158, and report logic 160 (each of which may be embodied as computer readable program code, firmware, or hardware, as an example). It should be understood that the data storage component 170 and/or the non-transitory memory component 152 may reside local to and/or remote from the computing apparatus 150, and may be configured to store one or more pieces of data for access by the computing apparatus 150 and/or other components.

A local interface 162 is also illustrated in FIG. 5 and may be implemented as a bus or other interface to facilitate communication among the components of the computing apparatus 150.

The one or processors 164 may include any processing component configured to receive and execute computer readable code instructions (such as from the data storage component 170 and/or non-transitory memory component 152). The input/output devices 166 include any device capable of providing input into the computing apparatus 150 (e.g., keyboards, touch screens, mouse devices, trackpads, microphones) and providing output from the computing apparatus 150 (e.g., electronic displays, speakers, haptic devices). The network interface hardware 168 may include any wired or wireless networking hardware, such as a modem, LAN port, wireless fidelity (Wi-Fi) card, WiMax card, mobile communications hardware, and/or other hardware for communicating with other networks and/or devices.

Included in the non-transitory memory component 152 may be the operating logic 154, prompt logic 156, model logic 158, and report logic 160. The operating logic 154 may include an operating system and/or other software for managing components of the computing apparatus 150. The prompt logic 156 may reside in the non-transitory memory component 152 and may be configured to receive one or more sets of vehicle system requirements, and generate a prompt for the trained model 134. The model logic 158 also may reside in the non-transitory memory component 152 and may be configured to effectuate the trained model 134 by receiving the prompt and producing an output report. The report logic 160 also may reside in the non-transitory memory component 152 and may be configured to receive the output from the trained model 134 and produce a report for viewing by users to identify any conflicts between vehicle system requirements.

It should be understood that the components illustrated in FIG. 5 are merely exemplary and are not intended to limit the scope of this disclosure. More specifically, while the components in FIG. 5 are illustrated as residing within a single computing apparatus 150, this is a non-limiting example. In some embodiments, one or more of the components may reside external to the computing apparatus 150.

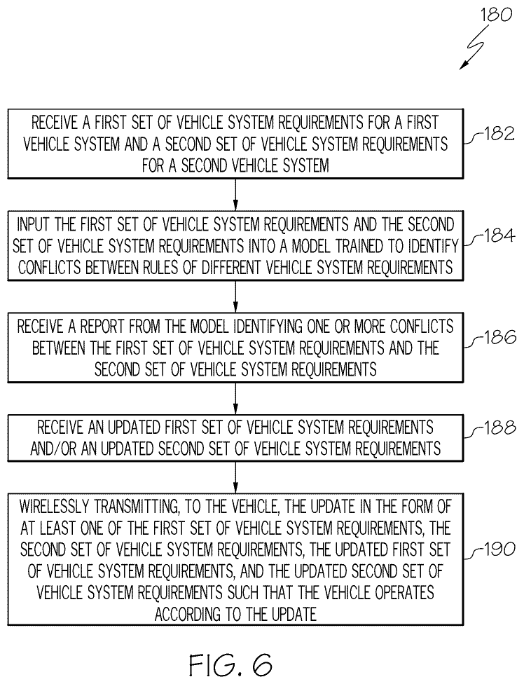

FIG. 6 illustrates an example method 180 for updating a vehicle. In block 182, the method 180 receives a first set of vehicle system requirements for a first vehicle system and a second set of vehicle system requirements for a second vehicle system. In block 184, the method 180 inputs the first set of vehicle system requirements and the second set of vehicle system requirements into a model trained to identify conflicts between rules of different vehicle system requirements. In block 186, the method 180 receives a report from the model identifying one or more conflicts between the first set of vehicle system requirements and the second set of vehicle system requirements. In block 188, the method 180 receives an updated first set of vehicle system requirements and/or an updated second set of vehicle system requirements. In block 190, the method 180 wirelessly transmits, to the vehicle, the update in the form of at least one of the first set of vehicle system requirements, the second set of vehicle system requirements, the updated first set of vehicle system requirements, and the updated second set of vehicle system requirements such that the vehicle operates according to the update.

It should now be understood that embodiments of the present disclosure are directed to systems and methods for identifying conflicts between sets of vehicle system requirements for different vehicle systems. A trained model receives sets of vehicle system requirements for different vehicle systems, and produces an output that includes any conflicts between the various requirements. Vehicle designers and other personnel may use this output to update the sets of vehicle system requirements as needed such that the conflicts are resolved. Updated sets of vehicle requirements may be transmitted to one or more vehicles by an update process.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of providing an update to a vehicle, the method comprising:
receiving a first set of vehicle system requirements for a first vehicle system and a second set of vehicle system requirements for a second vehicle system;
inputting the first set of vehicle system requirements and the second set of vehicle system requirements into a model trained to identify conflicts between rules of different vehicle system requirements;
receiving a report from the model identifying one or more conflicts between the first set of vehicle system requirements and the second set of vehicle system requirements;
receiving an updated first set of vehicle system requirements and/or an updated second set of vehicle system requirements; and
wirelessly transmitting, to the vehicle, the update in the form of at least one of the first set of vehicle system requirements, the second set of vehicle system requirements, the updated first set of vehicle system requirements, and the updated second set of vehicle system requirements such that the vehicle operates according to the update.

2. The method of claim 1, further comprising receiving operational data corresponding to at least one of the first set of vehicle system requirements and the second set of vehicle system requirements, wherein the model is further trained to identify conflicts between rules of different vehicle system requirements based on the operational data.

3. The method of claim 1, wherein the first set of vehicle system requirements comprises a governmental system requirements and the second set of vehicle system requirements comprises a manufacturer system requirements.

4. The method of claim 1, wherein the first vehicle system comprises a lane change system and the second vehicle system comprises a lane keeping system.

5. The method of claim 1, wherein the first set of vehicle system requirements comprises sensor capabilities.

6. The method of claim 5, wherein the updated first set of vehicle system requirements comprises one or more improved sensor capabilities.

7. The method of claim 1, further comprising receiving a plurality of additional sets of vehicle system requirements for a plurality of additional vehicle systems.

8. A computing apparatus comprising:
one or more processors; and
a non-transitory memory storing instructions that, when executed by the one or more processors, configure the computing apparatus to:
receive a first set of vehicle system requirements for a first vehicle system and a second set of vehicle system requirements for a second vehicle system;
input the first set of vehicle system requirements and the second set of vehicle system requirements into a model trained to identify conflicts between rules of different vehicle system requirements;
receive a report from the model identifying one or more conflicts between the first set of vehicle system requirements and the second set of vehicle system requirements;
receive an updated first set of vehicle system requirements and/or an updated second set of vehicle system requirements; and
wirelessly transmit, to the vehicle, an update in the form of at least one of the first set of vehicle system requirements, the second set of vehicle system requirements, the updated first set of vehicle system requirements, and the updated second set of vehicle system requirements such that the vehicle operates according to the update.

9. The computing apparatus of claim 8, wherein the instructions further configure the computing apparatus to receive operational data corresponding to at least one of the first set of vehicle system requirements and the second set of vehicle system requirements, wherein the model is further trained to identify conflicts between rules of different vehicle system requirements based on the operational data.

10. The computing apparatus of claim 8, wherein the first set of vehicle system requirements comprises a governmental system requirements and the second set of vehicle system requirements comprises a manufacturer system requirements.

11. The computing apparatus of claim 8, wherein the first vehicle system comprises a lane change system and the second vehicle system comprises a lane keeping system.

12. The computing apparatus of claim 8, wherein the first set of vehicle system requirements comprises sensor capabilities.

13. The computing apparatus of claim 12, wherein the updated first set of vehicle system requirements comprises one or more improved sensor capabilities.

14. The computing apparatus of claim 8, wherein the instructions further configure the computing apparatus to receive a plurality of additional sets of vehicle system requirements for a plurality of additional vehicle systems.

15. A system comprising:
a vehicle; and
a computing apparatus comprising:
one or more processors; and
a non-transitory memory storing instructions that, when executed by the one or more processors, configure the computing apparatus to:
receive a first set of vehicle system requirements for a first vehicle system and a second set of vehicle system requirements for a second vehicle system;
input the first set of vehicle system requirements and the second set of vehicle system requirements into a model trained to identify conflicts between rules of different vehicle system requirements;
receive a report from the model identifying one or more conflicts between the first set of vehicle system requirements and the second set of vehicle system requirements;
receive an updated first set of vehicle system requirements and/or an updated second set of vehicle system requirements; and
wirelessly transmit, to the vehicle, an update in the form of at least one of the first set of vehicle system requirements, the second set of vehicle system requirements, the updated first set of vehicle system requirements, and the updated second set of vehicle system requirements such that the vehicle operates according to the update.

16. The system of claim 15, wherein the instructions further configure the computing apparatus to receive operational data corresponding to at least one of the first set of vehicle system requirements and the second set of vehicle system requirements, wherein the model is further trained to identify conflicts between rules of different vehicle system requirements based on the operational data.

17. The system of claim 15, wherein the first set of vehicle system requirements comprises a governmental system requirements and the second set of vehicle system requirements comprises a manufacturer system requirements.

18. The system of claim 15, wherein the first vehicle system comprises a lane change system and the second vehicle system comprises a lane keeping system.

19. The system of claim 15, wherein:
the first set of vehicle system requirements comprises sensor capabilities; and
the updated first set of vehicle system requirements comprises one or more improved sensor capabilities.

20. The system of claim 15, wherein the instructions further configure the computing apparatus to receive a plurality of additional sets of vehicle system requirements for a plurality of additional vehicle systems.
